(19) United States
(12) Patent Application Publication
(10) Pub. No.: US 2023/0399021 A1
(43) Pub. Date: Dec. 14, 2023

(54) SYSTEMS AND METHODS FOR DETECTING RESTRICTED TRAFFIC ZONES FOR AUTONOMOUS DRIVING

(71) Applicant: TuSimple, Inc., San Diego, CA (US)

(72) Inventors: Bolun Zhang, San Diego, CA (US); Xiaodi Hou, San Diego, CA (US); Yao Xie, San Diego, CA (US); Robert August Rossi, JR., San Diego, CA (US)

(21) Appl. No.: 18/333,396

(22) Filed: Jun. 12, 2023

Related U.S. Application Data
(60) Provisional application No. 63/366,395, filed on Jun. 14, 2022.

(51) Int. Cl. B60W 60/00; B60W 40/04; B60W 40/105

(52) U.S. Cl. CPC B60W 60/0015; B60W 40/04; B60W 40/105; B60W 2552/53; B60W 2554/00; B60W 2556/40

(57) ABSTRACT

Systems and methods for detecting restricted traffic zones for autonomous driving are disclosed. In one aspect, method, includes receiving output from a perception system of an autonomous vehicle and detecting, based on the output from the perception system, one or more objects indicating a presence of a restricted traffic zone. The method may further include determining that the autonomous vehicle is entering the restricted traffic zone based on at least one of a prior map, an obstruction map, and the detected one or more objects.

### CROSS-REFERENCE TO RELATED APPLICATION(S)

This application claims the benefit of U.S. Provisional Application No. 63/366,395, filed Jun. 14, 2022, which is hereby incorporated by reference in its entirety. Any and all applications for which a foreign or domestic priority claim is identified in the Application Data Sheet as filed with the present application are hereby incorporated by reference under 37 CFR 1.57.

### BACKGROUND

### Field

The present disclosure relates generally to autonomous vehicles. More particularly, the present disclosure is related to systems and methods for detecting restricted traffic zones for autonomous driving.

### Description of the Related Art

One aim of autonomous vehicle technologies is to provide vehicles that can safely navigate towards a destination with limited or no driver assistance. The safe navigation of an autonomous vehicle (AV) from one point to another may include the ability to signal other vehicles, navigating around other vehicles in shoulders or emergency lanes, changing lanes, biasing appropriately in a lane, and navigating all portions or types of highway lanes.

### SUMMARY OF CERTAIN INVENTIVE ASPECTS

In one aspect, there is provided a method, comprising: receiving output from a perception system of an autonomous vehicle; detecting, based on the output from the perception system, one or more objects indicating a presence of a restricted traffic zone; and determining that the autonomous vehicle is entering the restricted traffic zone based on at least one of a prior map, an obstruction map, and the detected one or more objects.

In some embodiments, the prior map comprises a grid map defining a plurality of drivable lanes, and wherein the obstruction map includes a location for each of a plurality of obstructions in the restricted traffic zone.

In some embodiments, the method further comprises: generating a drivable area through the restricted traffic zone based on at least one of the prior map, the obstruction map, and the detected one or more objects.

In some embodiments, the method further comprises: determining, based on the drivable area, whether the autonomous vehicle can drive through the restricted traffic zone.

In some embodiments, the method further comprises: in response to determining that the autonomous vehicle cannot drive through the restricted traffic zone, causing the autonomous vehicle to perform a minimum risk condition maneuver.

In some embodiments, causing the autonomous vehicle to perform the minimum risk condition comprises determining, based on the drivable area, whether the autonomous vehicle should stop in a current lane, stop in an emergency lane, or stop on a different portion of the drivable area.

In some embodiments, the method further comprises: connecting the detected one or more objects to form a curve, wherein the generating the drivable area comprises using the curve as a boundary between the drivable area and a non-drivable area.

In some embodiments, the method further comprises: generating a lane map based on the drivable area, the lane map indicating one or more lanes in the drivable area that can be used to perform the minimal risk condition maneuver or used to drive the autonomous vehicle through the traffic restriction zone.

In some embodiments, the method further comprises: determining that the curve is parallel with a lane from the prior map and is within a predetermined distance of a boundary of the lane; and determining that the lane is closed based on determining that the curve is parallel with the lane and is within the predetermined distance of the boundary of the lane, wherein the lane map indicates that the lane is closed in response to determining that the lane is closed.

In some embodiments, the method further comprises: determining that the line makes an angle with a lane from the prior map that is greater than a predetermined angle; and determining that the lane is gradually closed based on determining that the curve makes the angle with the lane that is greater than the predetermined angle, wherein the lane map indicates that the lane is gradually closed in response to determining that the lane is gradually closed.

In some embodiments, the method further comprises: validating whether the lane map meets one or more validation requirements for updating the prior map; and providing the lane map to a prior map updating device in response to determining that the lane map meets the one or more validation requirements.

In some embodiments, the one or more validation requirements comprise one or more of the following between the lane map and the prior map: a continuity requirement, a connectiveness requirement, and a smoothness requirement.

In some embodiments, the method further comprises: determining that the autonomous vehicle can drive through the drivable area; and navigating the autonomous vehicle through the drivable area based on the lane map.

In some embodiments, the method further comprises: determining that a minimum width of the drivable area is less than a predetermined width; and in response to determining that the minimum width is less than the predetermined width, determining that the autonomous vehicle should perform the minimum risk condition maneuver.

In some embodiments, the method further comprises: receiving requirements for the autonomous vehicle to drive through the drivable area from a planning module of the autonomous vehicle; and determining whether the autonomous vehicle can drive through the drivable area or should perform a minimal risk condition maneuver based on the requirements.

In some embodiments, the requirements include one or more of the following: current traffic conditions, a current speed of the autonomous vehicle, and a current perception range of the perception system.

In some embodiments, the detected one or more objects comprise one or more of the following: a cone, a roadblock, a barricade, a barrier, a barrel, an emergency light, an emergency sign, an emergency vehicle, a vehicle, a pedestrian, a first responder, and a construction zone sign.

In some embodiments, the restricted traffic zone comprises one or more of the following: an emergency zone, a construction zone, a scene of an accident, a work zone, and a traffic control zone.

In another aspect, there is provided an apparatus comprising: at least one processor; and at least one memory including computer program code, the at least one memory and the computer program code configured to, with the at least one processor, cause the apparatus to: receive output from a perception system of an autonomous vehicle; detect presence of one or more emergency zone warning devices based on the output from the perception system; receive a prior map indicative of an environment in which the autonomous vehicle can drive; and determine that the autonomous vehicle is entering an emergency zone based on the detected presence of the one or more emergency zone warning devices and the prior map.

In yet another aspect, there is provided a non-transitory computer-readable medium storing computer program instructions which, when executed by at least one processor, cause the at least one processor to: receive output from a perception system of an autonomous vehicle; detect presence of one or more emergency zone warning devices based on the output from the perception system; receive a prior map indicative of an environment in which the autonomous vehicle can drive; and determine that the autonomous vehicle is entering an emergency zone based on the detected presence of the one or more emergency zone warning devices and the prior map.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic diagram of a system including an autonomous vehicle.

FIG. 2 shows a flow diagram for operation of an autonomous vehicle (AV) safely in light of the health and surroundings of the AV.

FIG. 3 illustrates a system that includes one or more autonomous vehicles, a control center or oversight system with a human operator (e.g., a remote center operator (RCO)), and an interface for third party interaction.

FIG. 4 is a flowchart illustrating a method for detecting restricted traffic zones for autonomous driving in accordance with aspects of this disclosure.

FIG. 5 is a block diagram illustrating a method for detecting restricted traffic zones for autonomous driving in accordance with aspects of this disclosure.

### DETAILED DESCRIPTION

Vehicles traversing highways and roadways are legally required to comply with regulations and statutes in the course of safe operation of the vehicle. For autonomous vehicles (AVs), particularly autonomous tractor trailers, the ability to recognize a malfunction in its systems and stop safely are necessary for lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

Aspects of this disclosure relate to systems and techniques which can detect restricted traffic zones for autonomous driving. In particular, it is desirable for an autonomous vehicle to be able to detect restricted traffic zones that includes objects that may not be present in a navigational map in order to determine whether the autonomous vehicle can safely continue driving through the detected area. Examples of such zones include: an emergency zone, a construction zone, a scene of an accident, a work zone, and a traffic control zone. By detecting restricted traffic zones, the autonomous vehicle can determine whether it is safe to continue driving through a detected restricted traffic zone or whether the autonomous vehicle should stop driving in order to avoid entering an area in which the autonomous vehicle cannot safely proceed.

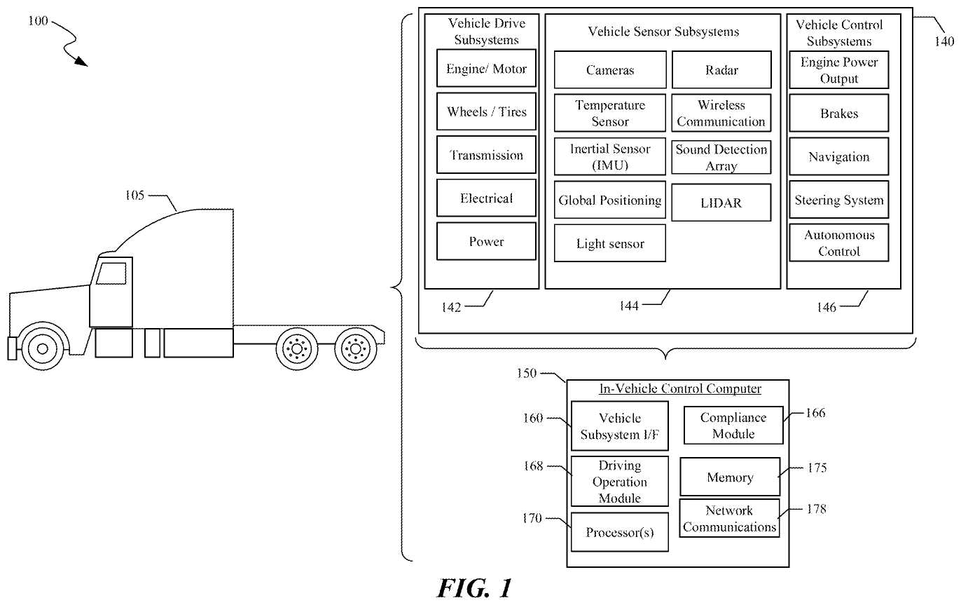

FIG. 1 shows a system 100 that includes a tractor 105 of an autonomous truck. The tractor 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the tractor 105 moves. The tractor 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the autonomous truck 105, including those which would indicate a malfunction in the AV or another cause for an AV to perform a limited or minimal risk condition (MRC) maneuver. The sensors for general operation of the autonomous vehicle may include cameras, a temperature sensor, an inertial sensor (IMU), a global positioning system (GPS), a light sensor, a light detection and ranging (LiDAR) system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous truck 105. Microphones used may be any suitable type, mounted such that they are effective both when the autonomous truck 105 is at rest, as well as when it is moving at normal driving speeds.

Cameras included in the vehicle sensor subsystems 144 may be rear-facing so that flashing lights from emergency vehicles may be observed from all around the autonomous truck 105. These cameras may include video cameras, cameras with filters for specific wavelengths, as well as any other cameras suitable to detect emergency vehicle lights based on color, flashing, of both color and flashing.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (e.g., LIDAR), the cameras, and/or other vehicle subsystems to determine the driving path or trajectory for the autonomous vehicle 105. The autonomous control that may activate systems that the autonomous vehicle 105 has which are not present in a conventional vehicle, including those systems which can allow the autonomous vehicle 105 to communicate with surrounding drivers or signal surrounding vehicles or drivers for safe operation of the autonomous vehicle 105.

The in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous truck 105 in response to information from the various vehicle subsystems 140. The one or more processors 170 execute the operations that allow the system to determine the health of the autonomous vehicle 105, such as whether the autonomous vehicle 105 has a malfunction or has encountered a situation requiring service or a deviation from normal operation and giving instructions. Data from the vehicle sensor subsystems 144 is provided to VCU 150 so that the determination of the status of the autonomous vehicle 105 can be made. The compliance module 166 may determine what action should be taken by the autonomous truck 105 to operate according to the applicable (i.e., local) regulations. Data from other vehicle sensor subsystems 144 may be provided to the compliance module 166 so that the best course of action in light of the AV's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. The autonomous control vehicle control subsystem may receive a course of action to be taken from the compliance module 166 of the VCU 150 and consequently relay instructions to other subsystems to execute the course of action.

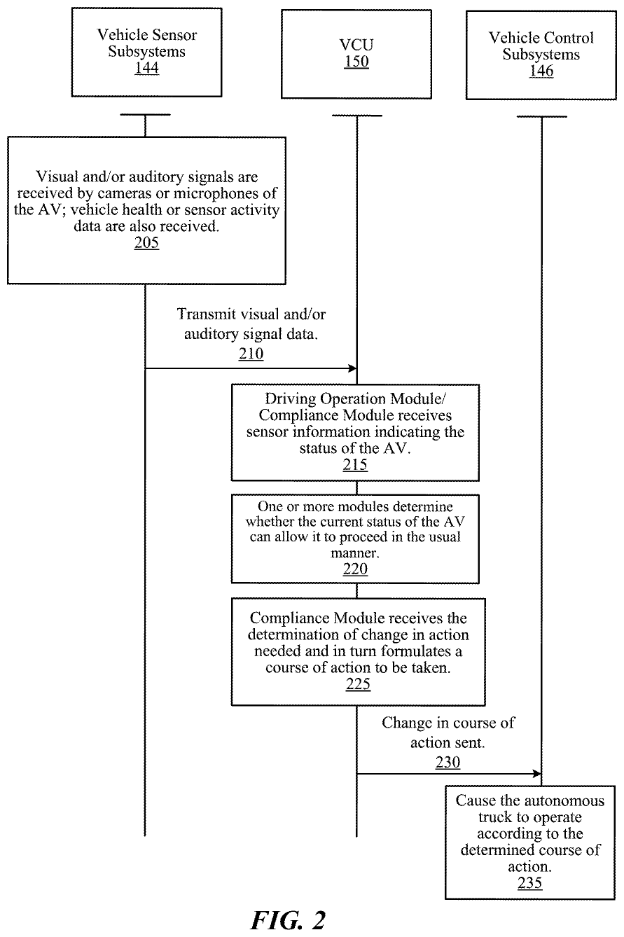

FIG. 2 shows a flow diagram for operation of an autonomous vehicle (AV) 105 safely in light of the health and surroundings of the autonomous vehicle 105. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

As shown in FIG. 2, the vehicle sensor subsystems 144 may receive visual, auditory, or both visual and auditory signals indicating the environmental condition of the autonomous vehicle 105 in step 205. The vehicle sensor subsystems 144 may also receive vehicle health or sensor activity data in step 205. These visual and/or auditory signal data are transmitted from the vehicle sensor subsystems 144 to the in-vehicle control computer system (VCU) 150, as in step 210. The driving operation module 168 and/or the compliance module 166 may receive the data transmitted from the vehicle sensor subsystems 144, in step 215. One or both of those modules may determine whether the current status of the autonomous vehicle 105 can allow it to proceed in the usual manner or that the autonomous vehicle 105 needs to alter its course to prevent damage or injury or to allow for service in step 220. The information indicating that a change to the course of the autonomous vehicle 105 is needed may include an indicator of sensor malfunction; an indicator of a malfunction in the engine, brakes, or other components necessary for the operation of the autonomous vehicle 105; a determination of a visual instruction from authorities such as flares, cones, or signage; a determination of authority personnel present on the roadway; a determination of a law enforcement vehicle on the roadway approaching the autonomous vehicle 105, including from which direction; and a determination of a law enforcement or first responder vehicle moving away from or on a separate roadway from the autonomous vehicle 105. This information indicating that a change to the AV's course of action is needed may be used by the compliance module 166 to formulate a new course of action to be taken which accounts for the AV's health and surroundings, in step 225. The course of action to be taken may include slowing, stopping, moving into a shoulder, changing route, changing lane while staying on the same general route, and the like. The course of action to be taken may include initiating communications with an oversight system (e.g., a control center) or human interaction systems present on the autonomous vehicle 105. The course of action to be taken may then be transmitted from the VCU 150 to the autonomous control system, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

### Autonomous Vehicle Oversight System

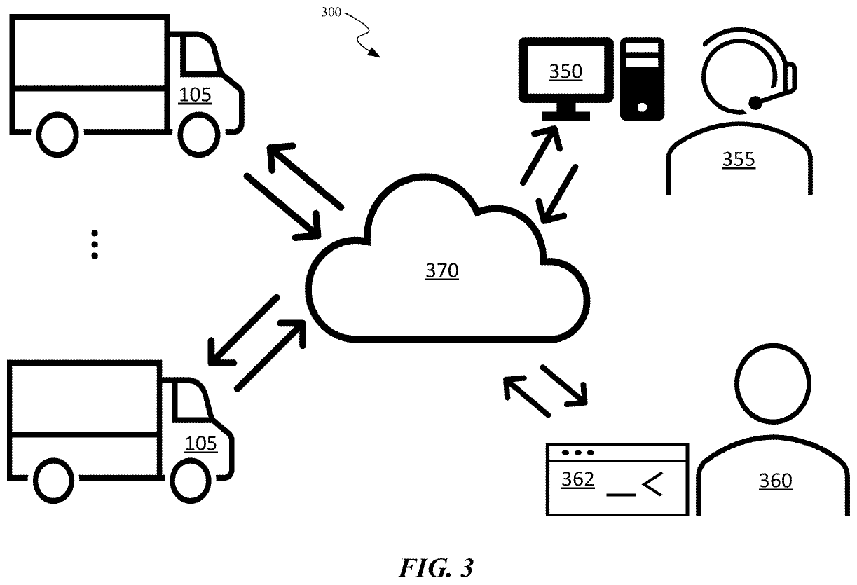

FIG. 3 illustrates a system 300 that includes one or more autonomous vehicles 105, a control center or oversight system 350 with a human operator 355, and an interface 362 for interaction with a third party 360. A human operator 355 may also be known as a remoter center operator (RCO). Communications between the autonomous vehicles 105, oversight system 350 and user interface 362 may take place over a network 370. In some instances, where not all the autonomous vehicles 105 in a fleet are able to communicate with the oversight system 350, the autonomous vehicles 105 may communicate with each other over the network 370 or directly. As described with respect to FIG. 1, the VCU 150 of each autonomous vehicle 105 may include a module for network communications 178.

An autonomous vehicle 105 may be in communication with the oversight system 350. The oversight system 350 may serve many purposes, including: tracking the progress of one or more autonomous vehicles 105 (e.g., an autonomous truck); tracking the progress of a fleet of autonomous vehicles 105; sending maneuvering instructions to one or more autonomous vehicles 105; monitoring the health of the autonomous vehicle(s) 105; monitoring the status of the cargo of each autonomous vehicle 105 in contact with the oversight system 350; facilitate communications between third parties (e.g., law enforcement, clients whose cargo is being carried) and each, or a specific, autonomous vehicle 105; allow for tracking of specific autonomous vehicles 105 in communication with the oversight system 350 (e.g., third party tracking of a subset of vehicles in a fleet); arranging maintenance service for the autonomous vehicles 105 (e.g., oil changing, fueling, maintaining the levels of other fluids); alerting an affected autonomous vehicle 105 of changes in traffic or weather that may adversely impact a route or delivery plan; pushing over the air updates to autonomous vehicles 105 to keep all components up to date; and other purposes or functions that improve the safety for the autonomous vehicle 105, its cargo, and its surroundings. An oversight system 350 may also determine performance parameters of the autonomous vehicle 105 (e.g. an autonomous truck), including any of: data logging frequency, compression rate, location, data type; communication prioritization; how frequently to service the autonomous vehicle 105 (e.g., how many miles between services); when to perform a minimal risk condition (MRC) maneuver while monitoring the vehicle's progress during the maneuver; when to hand over control of the autonomous vehicle 105 to a human driver (e.g., at a destination yard); ensuring the autonomous vehicle 105 passes pre-trip inspection; ensuring the autonomous vehicle 105 performs or conforms to legal requirements at checkpoints and weight stations; ensuring the autonomous vehicle 105 performs or conforms to instructions from a human at the site of a roadblock, cross-walk, intersection, construction, or accident; and the like.

To allow for communication between autonomous vehicles 105 in a fleet and the oversight system 350, each autonomous vehicle 105 may be equipped with a communication gateway. The communication gateway may have the ability to do any of the following: allow for AV to oversight system communication (i.e. V2C) and the oversight system to AV communication (C2V); allow for AV to AV communication within the fleet (V2V); transmit the availability or status of the communication gateway; acknowledge received communications; ensure security around remote commands between the autonomous vehicle 105 and the oversight system 350; convey the autonomous vehicle's location reliably at set time intervals; enable the oversight system 350 to ping the autonomous vehicle 105 for location and vehicle health status; allow for streaming of various sensor data directly to the oversight system 350; allow for automated alerts between the autonomous vehicle 105 and the oversight system 350; comply to ISO 21434 standards; and the like.

The oversight system 350 may be operated by one or more human, also known as an operator or a remote center operator (RCO) 355. The operator 355 may set thresholds for autonomous vehicle health parameters, so that when an autonomous vehicle 105 meets or exceeds the threshold, precautionary action may be taken. Examples of vehicle health parameters for which thresholds may be established by the operator 355 may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LiDAR, radar, microphone array malfunction); computing resources ability (e.g., VCU or ECU malfunction or lack of responsiveness, temperature abnormalities in computing units); angle between a tractor and trailer of the autonomous vehicle 105 in a towing situation (e.g., tractor-trailer, 18-wheeler, or semi-truck); unauthorized access by a living entity (e.g., a person or an animal) to the interior of the autonomous vehicle 105; and the like. The precautionary action may include execution of a minimal risk condition (MRC) maneuver, seeking service, or exiting a highway or other such re-routing that may be less taxing on the autonomous vehicle 105. An autonomous vehicle 105 whose system health data meets or exceeds a threshold set at the oversight system 350 or by the operator 355 may receive instructions that are automatically sent from the oversight system 350 to perform the precautionary action.

The operator 355 may be made aware of situations affecting one or more autonomous vehicles 105 in communication with or being monitored by the oversight system 350 that the affected autonomous vehicle(s) 105 may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle 105 may be brought to the attention of the operator 355 through traffic reports, law enforcement communications, data from other vehicles that are in communication with the oversight system 350, reports from drivers of other vehicles in the area, and similar distributed information venues. The autonomous vehicle 105 may not be able to detect such situations because of limitations of sensor systems or lack of access to the information distribution means (e.g., no direct communication with weather agency). An operator 355 at the oversight system 350 may push such information to affected autonomous vehicles 105 that are in communication with the oversight system 350. The affected autonomous vehicles 105 may proceed to alter their route, trajectory, or speed in response to the information pushed from the oversight system 350. In some instances, the information received by the oversight system 350 may trigger a threshold condition indicating that MRC (minimal risk condition) maneuvers are warranted; alternatively, or additionally, an operator 355 may evaluate a situation and determine that an affected autonomous vehicle 105 should perform an MRC maneuver and subsequently send such instructions to the affected vehicle. In these cases, each autonomous vehicle 105 receiving either information or instructions from the oversight system 350 or the operator 355 uses its on-board computing unit (i.e. VCU) to determine how to safely proceed, including performing an MRC maneuver that includes pulling-over or stopping.

### Systems and Methods for Detecting Restricted Traffic Zones for Autonomous Driving

As described herein, aspects of this disclosure relate to systems and techniques which can detect restricted traffic zones for autonomous driving such that the autonomous vehicle 105 can determine whether it is safe to continue driving through a detected restricted traffic zone or whether the autonomous vehicle 105 should stop driving in order to avoid entering an area in which the autonomous vehicle 105 cannot safely proceed. Examples of such zones include: an emergency zone, a construction zone, a scene of an accident, a work zone, and a traffic control zone.

When the autonomous vehicle 105 determines that it cannot safely navigate the restricted traffic zone, the autonomous vehicle 105 may terminate autonomous navigation by stopping the autonomous vehicle 105 in its current lane and/or pulling over to the side of the road. In some situations, the autonomous vehicle 105 can be configured to perform an MRC maneuver in which the autonomous vehicle 105 autonomously maneuvers to a stopping location. In some embodiments, the MRC maneuver can be performed under supervision of an operator 355 via the oversight system 350.

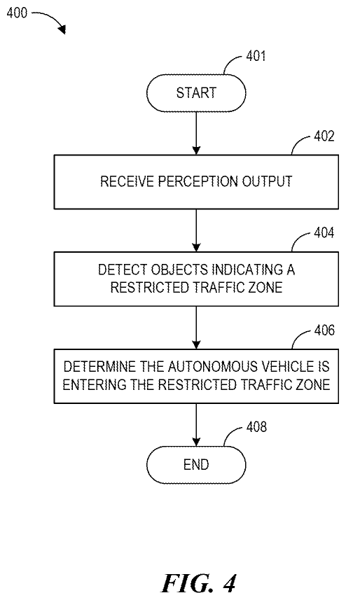

FIG. 4 is a flowchart illustrating a method 400 for detecting restricted traffic zones for autonomous driving in accordance with aspects of this disclosure. With reference to FIG. 4, one or more blocks of the method 400 may be implemented, for example, by a processor such as the VCU 150 of the autonomous vehicle 105. The method 400 begins at block 401.

At block 402, the processor may receive output from a perception system of an autonomous vehicle. As used herein, the perception system may be used to refer to any and all of the vehicle sensor subsystems 144 illustrated in FIG. 1. The processor may also receive a prior map and/or an obstruction map, which may be stored in the memory 175.

At block 404, the processor may detect, based on the output from the perception system, one or more objects indicating a presence of a restricted traffic zone. For example, the processor may be configured to detect objects that are used by workers to signal the presence of a restricted traffic zone and/or objects that are typically found in restricted traffic zones. Examples of such objects include cones, roadblocks, barricades, barriers, barrels, emergency lights, emergency signs, emergency vehicles, other types of vehicles, pedestrians, first responders, and construction zone signs.

At block 406, the processor may determine that the autonomous vehicle 105 is entering the restricted traffic zone based on at least one of the prior map, the obstruction map, and the detected one or more objects. The method 400 ends at block 408.

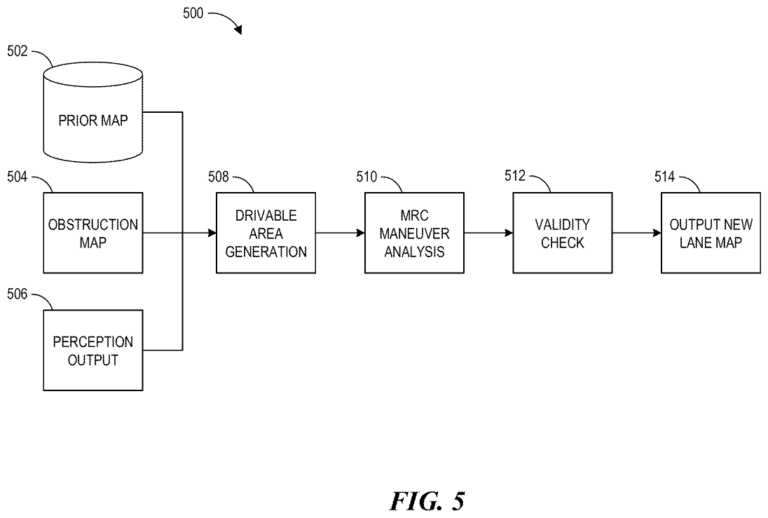

FIG. 5 is a block diagram 500 illustrating a method for detecting restricted traffic zones for autonomous driving in accordance with aspects of this disclosure. In particular, FIG. 5 provides more detailed sub-blocks which may be implemented when performing the method 400 of FIG. 4. With reference to FIG. 5, one or more blocks of the method 500 may be implemented, for example, by a processor such as the VCU 150 of the autonomous vehicle 105.

With reference to FIG. 5, the processor may receive a prior map 502 (also referred to as a TsMap), an obstruction map 504, and perception output 506. In particular, the processor may receive the prior map 502 and the obstruction map 504 from memory 175 and the perception output 506 from the perception system (e.g. the vehicle sensor subsystems of FIG. 1).

In some implementations, the prior map 502 includes a grid map defining a plurality of drivable lanes in which the autonomous vehicle 105 can drive. The prior map 502 may include a navigational map with lane level detail sufficient for planning a route between a current location of the autonomous vehicle 105 and a destination that can be used for autonomous driving.

The obstruction map 504 may include data indicating the location for each of a plurality of obstructions in and/or near the environment in which the autonomous vehicle 105 can drive including in the restricted traffic zone. For example, the obstruction map 504 may be a grid-based map that records prior information for static objects (e.g., objects that typically do not change position). In some embodiments, the obstruction map 504 may be an occupancy grid map that, for each position or voxel, indicates whether a static object is present (e.g., whether the position is occupied) and may include other information such as the type or semantic label of the object. Together, the prior map 502 and the obstruction map 504 provide information regarding the drivable roads and objects on or near the roads with sufficient precision for the autonomous vehicle 105 to navigate to its destination.

However, the prior map 502 and the obstruction map 504 may provide no or insufficient information on the current state of the roadways and/or objects (e.g., static or dynamic objects) on or near the roadways. For example, when a new restricted traffic zone such as a construction zone is established, the prior map 502 and the obstruction map 504 may not have any information on the drivable areas within the restricted traffic zone. Accordingly, the processor may be configured to supplement the prior map 502 and the obstruction map 504 with information received from the perception system.

The perception output 506 can include an occupancy grid map including objects detected by the sensor(s) of the vehicle sensor subsystems 144. The perception system may be configured to interpret the raw data received from the vehicle sensor subsystems 144 and generate the occupancy grid map including occupancy and/or semantic labels for each detected object. For example, the perception system can classify the objects into one or more of the following semantic labels: cones, roadblocks, barricades, barriers, barrels, emergency lights, emergency signs, emergency vehicles, other types of vehicles, pedestrians, first responders, and construction zone signs.

At block 508, the processor may generate a drivable area through the restricted traffic zone based on at least one of the prior map 502, the obstruction map 504, and the detected one or more objects. As part of block 508, the processor may also determine whether the autonomous vehicle 105 is entering a restricted traffic zone based on the prior map 502, the obstruction map 504, and the perception output 506. In some implementations, the processor may also determine the type of the restricted traffic zone (e.g., an emergency zone, a work zone, or a traffic control zone).

The processor may use one or more of the objects from the perception output 506 in generating the drivable area. For example, the processor may connect a plurality of the objects to form a curve and use the curve as a boundary between the drivable area and a non-drivable area. For example, when the objects include a plurality of cones, the cones may have been placed by a worker to delineate the boundary of the drivable area within the restricted traffic zone. Thus, by connecting the cones into a curve, the processor can generate the boundary between the drivable and non-drivable areas based on the information communicated by the presence of the cones. The processor may determine the boundary using a similar process for other objects that indicate the boundary of the drivable area. For example, the processor may form curves based on the location of roadblocks, barricades, barriers, and/or barrels.

The processor may also generate a lane map of the drivable area. The lane map may indicate one or more lanes in the drivable area that can be used to perform the minimal risk condition maneuver or be used to drive the autonomous vehicle 105 through the traffic restriction zone. In some embodiments, in generating the lane map the processor may modify the lane map from the prior map 502 based on the objects from the perception output 506. For example, the processor may modify the lane map based on one or more conditions regarding the relative positioning of the objects and the lanes indicated by the lane map.

In a first example, the processor may determine whether a curve formed by the objects is substantially parallel with a lane from the prior map 502 (e.g., an angle between the curve and a lane marker defining a boundary of the lane is less than a predetermined angle) and within a predetermined distance of the boundary of the lane. The processor may determine that the lane is closed based on determining that the curve is parallel with the lane and is within the predetermined distance of the boundary of the lane. The processor can then generate the lane map to indicate that the lane is closed in response to determining that the lane is closed. As part of generating an indication that the lane is closed, the processor may generate boundaries for the lane closure (e.g., boundaries of the restricted traffic zone).

In a second example, the processor may determine whether the curve makes an angle with a lane from the prior map 502 that is greater than a predetermined angle. The processor may determine that the lane is gradually closed based on determining that the curve makes the angle with the lane greater than the predetermined angle. The processor can then generate the lane map to indicate that the lane is gradually closed in response to determining that the lane is gradually closed.

In a third example, the processor may determine that the curve does not meet the criteria for either of the first and second examples discussed above. In this case, the processor may determine one or more new lanes based on the location of the curve. For example, the processor may identify a new lane substantially parallel to the curve. This new lane may not be fixed to the position of any lane within the prior map 502. The generation of the new lane map may be analogous to shifting the position of the prior lanes and/or “repainting” the lanes based on the location of the curve.

At block 510, the processor may perform an MRC maneuver analysis to determine, based on the drivable area through the restricted area, whether the autonomous vehicle 105 can drive through the restricted traffic zone or if the autonomous vehicle 105 should perform an MRC maneuver to stop in its current lane or stop in an emergency lane.

In some implementations, the processor may receive requirements for the autonomous vehicle 105 to drive through the drivable area of the restricted traffic zone from a planning module of the autonomous vehicle 105. The processor may determine whether the autonomous vehicle 105 can drive through the drivable area of the restricted traffic zone or should perform an MRC maneuver based on the requirements.

In some implementations, one or more of the requirements used for determining whether the autonomous vehicle 105 can drive through the restricted traffic zone may vary depending on the current conditions of the environment. For example, the requirements can include one or more of the following: current traffic conditions, a current speed of the autonomous vehicle 105, a current perception range of the perception system, and a minimum width of the drivable area.

For example, the processor can determine whether a minimum width of the drivable area is less than a predetermined width. In response to determining that the minimum width is less than the predetermined width, the processor may determine that the autonomous vehicle 105 should perform the MRC maneuver. In some implementations, the predetermined width may be 3 meters, however, this disclosure is not limited thereto and the predetermined width may be less than or greater than 3 meters. Depending on the embodiment, the predetermined width may be based on a width of the autonomous vehicle 105.

In response to determining that the autonomous vehicle 105 cannot drive through the restricted traffic zone, the processor may cause the autonomous vehicle 105 to perform the MRC maneuver. The processor may also determine whether the MRC maneuver should include the autonomous vehicle 105 stopping in a current lane, stopping in an emergency lane, or stopping on a different portion of the drivable area based on the drivable area.

At block 512, the processor may perform a validity check to determine whether any portion of the drivable area can be output as a new lane map. In some embodiments, the processor may validate whether the lane map meets one or more validation requirements for updating the prior map 502. The processor may provide the lane map to a prior map updating device (e.g., via the oversight system 350) in response to determining that the lane map meets the one or more validation requirements. The one or more validation requirements may include one or more of the following between the lane map and the prior map: a continuity requirement, a connectiveness requirement, and a smoothness requirement.

At block 514, the processor may output the new lane map in response to the new lane map passing the validity check of block 512. For example, the processor may provide the new lane map to the prior map updating device. The processor may also determine that the autonomous vehicle 105 can drive through the drivable area and navigate the autonomous vehicle 105 through the drivable area based on the lane map.

In some embodiments, the autonomous vehicle 105 may record the results of the method implemented by the block diagram 500 regardless of whether the new lane map passes the validity check of block 512. For example, the autonomous vehicle 105 may provide the data generated by the method of FIG. 5 to the oversight system 300 or another centralized server to identify false positives and/or false negatives. This data can be used to improve the method when executed by autonomous vehicles 105 in the future. For example, the requirements for the autonomous vehicle 105 to drive through the drivable area and/or the one or more validation requirements can be adjusted based on the data generated by one or more autonomous vehicles 105 executing the method of FIG. 5.

In some embodiments, the processor can also use map hard boundaries and/or soft boundaries to determine whether to use an identified restricted traffic zone in navigating the autonomous vehicle 105 to reduce false positives in which the detected restricted traffic zone would negatively impact the navigation of the autonomous vehicle 105. For example, the processor can use the hard boundaries and/or soft boundaries to determine whether to use the determination that a given lane is closed in navigating the autonomous vehicle 105. In certain implementations, the prior map 502 can include the location(s) of any hard boundaries and/or soft boundaries near the roadway. A hard boundary can include, for examples, boundaries adjacent to the roadway which a vehicle cannot physically cross. Examples of hard boundaries can include: hard rails and/or concrete walls. A soft boundary can include, for example, boundaries adjacent to the roadway which a vehicle can physically cross. Examples of soft boundaries can include: pavement boundaries of the road (e.g., the boundary between pavement and the unpaved ground next to the pavement).

The processor can determine whether the boundaries of a restricted traffic zone (e.g., a lane closure) are located outside of a hard boundary (e.g., on the opposite side of the hard boundary with respect to the autonomous vehicle 105). In response to determining that the boundaries of the restricted traffic zone are located outside of the hard boundary, the processor can refrain from using the determined restricted traffic zone in navigating the autonomous vehicle 105.

The processor can determine whether the boundaries of a restricted traffic zone (e.g., a lane closure) are located farther than a predetermined distance outside of a soft boundary (e.g., on the opposite side of the soft boundary with respect to the autonomous vehicle 105). In response to determining that the boundaries of the restricted traffic zone are located farther than the predetermined distance outside of the soft boundary, the processor can refrain from using the determined restricted traffic zone in navigating the autonomous vehicle 105. In response to the restricted traffic zone being closer than the predetermined distance outside of the soft boundary, the processor may use the restricted traffic zone in navigating the autonomous vehicle 105. For example, as described herein, the processor may cause the autonomous vehicle 105 to slow down, change lanes, and/or perform an MRC based on the identified restricted traffic zone.

By refraining from using the detected restricted traffic zone under certain conditions (e.g., when the restricted traffic zone is outside of a hard boundary and/or farther than a predetermine distance outside of the soft boundary), the processor can reduce the occurrence of false positives which could cause the processor to decelerate the autonomous vehicle 105. Thus, the processor can continue to navigate the autonomous vehicle 105 with fewer false positives when the detected restricted traffic zone will not affect the drivable area available for the autonomous vehicle 105.

In certain embodiments, the processor can further be configured to apply a temporal cone filter to reduce false positives associated with detected cones. As described herein, the processor can be configured to determine the boundary of a restricted traffic zone (e.g., a lane closure) based on the detected locations of cones and/or posts. However, under certain circumstances, the processor may detect a cone or post that represents a false positive for the location of the boundary. For example, one or more cone(s) and/or post(s) may have been moved from their initial locations, and thus, the location(s) of the moved cone(s) and/or post(s) may be falsely interpreted as the boundary of the restricted traffic zone. By using the temporal cone filter, the processor can reduce the occurrence of false positives due to change(s) in the locations of cone(s) and/or post(s).

As part of implementing the temporal cone filter, the processor can divide the roadway into a grid. Depending on the embodiment, the grid may be the same as the grid of the occupancy grid map generated based on the perception output 506. However, in other embodiments, the grid used in the temporal cone filter may be independent of other grids generated by the processor. In some embodiments, the grid can include a coordinate system, such as an east-north-up (ENU) coordinate system, however, aspects of this disclosure are not limited thereto. In one example, the grid may be formed of 1 meter by 1 meter square grid positions.

The processor can assign each of the cones and/or posts detected in the perception output 506 to a position within the grid. The processor can determine whether the number of cones and/or posts within a given grid position is greater than a threshold number. In response to determining that the number of cones and/or posts within the given grid position is greater than the threshold number, the processor can determine that the grid position forms part of the boundary of the restricted traffic zone (e.g., the lane closure). When the number of cones and/or posts within the given grid position is equal to or less than the threshold number, the processor can determine that the grid position does not form part of the boundary of the restricted traffic zone (e.g., the lane closure), in other words, filtering any cones or posts detected at the given grid position. By filtering the cones and/or posts in this way, the processor can reduce the number of false positives described above.

As part of detecting restricted traffic zones, for example, as discussed in connection with the method 400 and/or the block diagram 500, the processor may determine one or more sets of data that can be provided to the vehicle control subsystem 146 for navigating the autonomous vehicle 105. Depending on the embodiment, the processor can determine one or more of the following: the number of lanes closed due to the restricted traffic zone, the area of the restricted traffic zone, one or more boundaries of the restricted traffic zone, or the direction associated with the restricted traffic zone (e.g., whether the restricted traffic zones is on the left side or the right side of the roadway).

Depending on the distance between the current location of the autonomous vehicle 105 and the restricted traffic zone, the processor may not be able to accurately determine each of the above described sets of data to be provided to the vehicle control subsystem 146. For example, when the autonomous vehicle 105 is farther away from the restricted traffic zone than a threshold distance (e.g., 200 meters), the perception output 506 may not have sufficient detail to determine, for example, the boundary of the restricted traffic zone and/or the number of lanes that are closed in the restricted traffic zone with sufficient accuracy. Thus, when the autonomous vehicle 105 is farther away from the restricted traffic zone than the threshold distance, the processor may only provide a subset of the sets of data related to the restricted traffic zone to the vehicle control subsystem 146.

In some implementations, the processor may determine a confidence level for each set of data associated with the restricted traffic zone. The processor can provide each set of data that has a confidence level higher than a threshold level to the vehicle control subsystem 146. In other implementations, the processor can be configured to determine a range for the restricted traffic zone when the restricted traffic zone is farther away from the autonomous vehicle 105 than the threshold distance. The processor can provide the range for the restricted traffic zone to the vehicle control subsystem 146 in place of the other sets of data when farther away from the restricted traffic zone than the threshold distance. This can reduce false positives (e.g., in determining the number of lanes closed), when the perception output 506 may not have sufficient detail (e.g., to determine the number of lanes closed). Conclusion

Though much of this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A method, comprising:
receiving output from a perception system of an autonomous vehicle;
detecting, based on the output from the perception system, one or more objects indicating a presence of a restricted traffic zone; and
determining that the autonomous vehicle is entering the restricted traffic zone based on at least one of a prior map, an obstruction map, and the detected one or more objects.

2. The method of claim 1, wherein the prior map comprises a grid map defining a plurality of drivable lanes, and wherein the obstruction map includes a location for each of a plurality of obstructions in the restricted traffic zone.

3. The method of claim 1, further comprising:
generating a drivable area through the restricted traffic zone based on at least one of the prior map, the obstruction map, and the detected one or more objects.

4. The method of claim 3, further comprising:
determining, based on the drivable area, whether the autonomous vehicle can drive through the restricted traffic zone.

5. The method of claim 4, further comprising:
in response to determining that the autonomous vehicle cannot drive through the restricted traffic zone, causing the autonomous vehicle to perform a minimum risk condition maneuver.

6. The method of claim 5, wherein causing the autonomous vehicle to perform the minimum risk condition comprises determining, based on the drivable area, whether the autonomous vehicle should stop in a current lane, stop in an emergency lane, or stop on a different portion of the drivable area.

7. The method of claim 6, further comprising:
connecting the detected one or more objects to form a curve,
wherein the generating the drivable area comprises using the curve as a boundary between the drivable area and a non-drivable area.

8. The method of claim 7, further comprising:
generating a lane map based on the drivable area, the lane map indicating one or more lanes in the drivable area that can be used to perform the minimal risk condition maneuver or used to drive the autonomous vehicle through the traffic restriction zone.

9. The method of claim 8, further comprising:
determining that the curve is parallel with a lane from the prior map and is within a predetermined distance of a boundary of the lane; and
determining that the lane is closed based on determining that the curve is parallel with the lane and is within the predetermined distance of the boundary of the lane,
wherein the lane map indicates that the lane is closed in response to determining that the lane is closed.

10. The method of claim 8, further comprising:
determining that the curve makes an angle with a lane from the prior map that is greater than a predetermined angle; and
determining that the lane is gradually closed based on determining that the curve makes the angle with the lane that is greater than the predetermined angle,
wherein the lane map indicates that the lane is gradually closed in response to determining that the lane is gradually closed.

11. The method of claim 8, further comprising:
validating whether the lane map meets one or more validation requirements for updating the prior map; and
providing the lane map to a prior map updating device in response to determining that the lane map meets the one or more validation requirements.

12. The method of claim 11, wherein the one or more validation requirements comprise one or more of the following between the lane map and the prior map: a continuity requirement, a connectiveness requirement, and a smoothness requirement.

13. The method of claim 8, further comprising:
determining that the autonomous vehicle can drive through the drivable area; and
navigating the autonomous vehicle through the drivable area based on the lane map.

14. The method of claim 5, further comprising:
determining that a minimum width of the drivable area is less than a predetermined width; and
in response to determining that the minimum width is less than the predetermined width, determining that the autonomous vehicle should perform the minimum risk condition maneuver.

15. The method of claim 3, further comprising:
receiving requirements for the autonomous vehicle to drive through the drivable area from a planning module of the autonomous vehicle; and
determining whether the autonomous vehicle can drive through the drivable area or should perform a minimal risk condition maneuver based on the requirements.

16. The method of claim 15, wherein the requirements include one or more of the following: current traffic conditions, a current speed of the autonomous vehicle, and a current perception range of the perception system.

17. The method of claim 1, wherein the detected one or more objects comprise one or more of the following: a cone, a roadblock, a barricade, a barrier, a barrel, an emergency light, an emergency sign, an emergency vehicle, a vehicle, a pedestrian, a first responder, and a construction zone sign.

18. The method of claim 1, wherein the restricted traffic zone comprises one or more of the following: an emergency zone, a construction zone, a scene of an accident, a work zone, and a traffic control zone.

19. An apparatus comprising:
at least one processor; and
at least one memory including computer program code, the at least one memory and the computer program code configured to, with the at least one processor, cause the apparatus to:
receive output from a perception system of an autonomous vehicle;
detect presence of one or more emergency zone warning devices based on the output from the perception system;
receive a prior map indicative of an environment in which the autonomous vehicle can drive; and
determine that the autonomous vehicle is entering an emergency zone based on the detected presence of the one or more emergency zone warning devices and the prior map.

20. A non-transitory computer-readable medium storing computer program instructions which, when executed by at least one processor, cause the at least one processor to:
receive output from a perception system of an autonomous vehicle;
detect presence of one or more emergency zone warning devices based on the output from the perception system;
receive a prior map indicative of an environment in which the autonomous vehicle can drive; and
determine that the autonomous vehicle is entering an emergency zone based on the detected presence of the one or more emergency zone warning devices and the prior map.
